(19) United States
(12) Patent Application Publication
(10) Pub. No.: US 2012/0167997 A1
(43) Pub. Date: Jul. 5, 2012

(54) COUPLING AND SWITCHING ELEMENT FOR LINES FOR TRANSPORTING FLUIDS

(75) Inventors: Karl August Brensing, Bonn (DE); Michael Dedenbach, Bonn (DE); Rainer Kluth, Bonn (DE)

(73) Assignee: KARL AUGUST BRENSING, BONN (DE)

(21) Appl. No.: 13/390,150

(22) PCT Filed: Aug. 16, 2010
(86) PCT No.: PCT/EP10/61907

§ 371 Date: Feb. 13, 2012

(30) Foreign Application Priority Data
Aug. 14, 2009 (DE) 10 2009 026 375.6

(51) Int. Cl. G05D 11/00

(52) U.S. Cl. 137/14; 137/115.03; 137/115.11

(57) ABSTRACT

A coupling and switching unit for transporting a gas-containing fluid includes at least one line having at least one coupling device. The at least one line is configured as a feed line for a gas/liquid mixture. A branched-off line is arranged at the end of the at least one line. The branched-off line is configured to direct the liquid/gas mixture towards an outflow. A throttle valve is arranged in the branched-off line. A valve is configured to control a discharge of a main flow of the gas/liquid mixture.

### CROSS REFERENCE TO PRIOR APPLICATIONS

This application is a U.S. National Phase application under 35 U.S.C. §371 of International Application No. PCT/EP2010/061907, filed on Aug. 16, 2010 and which claims benefit to German Patent Application No. 10 2009 026 375.6, filed on Aug. 14, 2009. The International Application was published in German on Feb. 17, 2011 as WO 2011/018528 A1 under PCT Article 21(2).

### FIELD

The present invention provides a coupling and switching unit, such as for branch lines for connection to ring line systems to transport fluids, such as gas-containing fluids, to end consumers (for example, dialysis units, tapping points of liquid vending machines).

### BACKGROUND

Hygienically questionable states may occur in systems that are exposed to liquids, for example, water. Biofilms may, for example, form on walls of lines. These comprise biocenoses that allow microbial life embedded in a matrix of extracellular polymeric substances. One of the functions of the extracellular polymeric substances is to provide external protection from pH fluctuations, salts, hydraulic loading, toxic heavy metals, antibiotics and immune defense mechanisms. The matrix structure leads to an enormously high resistance of the lifeforms concerned, which for these reasons are sometimes up to thousands of times more resistant to antimicrobial agents than the individual organisms (Gilbert, P., Das, J. and Foley, I. (1997) Biofilm susceptibility to antimicrobials Adv Dent Res 11(1): 160-167; Costerton, J. W. Stuart, P. S. and Bönberg, E. P. (1999) Bacterial biofilms: a common cause of persistent infections, Science 284: 1318-1322).

Studies have shown that a large proportion of infections are caused by such biofilms and that they may have life-threatening effects, for example, in hospitals (Lasa, I., Del Pozo, J. L., Penades, J. R., Leiva, J. (2005) Bacterial biofilms and infection, An. Sist. Sanit. Navar. 28: 163-175). Problematic biofilm bacteria include Pseudomonas aeruginosa, Legionella pneumophila, Acinetobacter, atypical mycobacteria and Serratia. Pseudomonas aeruginosa are attributable to contaminated tap water (Reuter, S., Sigge, A., Reuter, U. et al. (2002) Endemische Übertragungswege von Pseudomonas aeruginosa [endemic means of transmission of Pseudomonas aeruginosa], Hyg Mikrobiol 6: 6-12). Such infections therefore represent a considerable problem, for example, in intensive care units, dialysis centers or surgery departments.

The formation of biofilms is a considerable potential hazard, for example, in the case of dialyses. This is so because certain elements of the water treatment installations of dialysis devices, for example, filters, ion exchangers or membranes, are conducive to the development of such biofilms. Additional factors that are conducive to the breeding of bacteria are, for example, dead spaces in water pipeline systems, low or no rates of flow and the use of bicarbonate concentrate, which is used for preparing the dialyzing fluids.

Among the suitable disinfectants is ozone. This gas has been used, for example, in the food industry, in the treatment of drinking and waste water, and in dental treatment. Corresponding installations for the use of ozone are described, for example, in DE 10061890 A1, DE 1016365 A1, DE 29806719 U1, DE 3225674 A1, DE 202008001211 U1 and EP 0 577 475 A1.

Ozone has found little use in dialysis devices. Brensing et al. Hyg Med 2009, 34, nevertheless describes what advantages are gained by daily ozonizing of the watering systems of dialysis devices. However, no solution in terms of process engineering and equipment is provided. There is therefore a great need for solutions for the use of ozone, for example, in the area of dialysis. This is so because the materials that are usually used for the ring line systems are not thermally stable. Although PVC surfaces are of advantage for delaying the occurrence of biofilms, disinfection by using heat is not suitable for dialysis devices because of the lack of thermal stability. In cases where thermally stable lines are used, the disinfecting processes are very water-intensive and use considerable amounts of energy; over 80° C. is reached in the case of this process by means of heat. A further problem arises in the case of emergency dialyses that have to be carried out within a short time. This is so because disinfection by using heat may require cooling times of 2 to 3 hours before a dialysis can be safely performed.

Methods for connecting dialysis units to extremely pure water systems in which deposits of bacteria are intended to be prevented are described, for example, in DE 19931304 A1, DE 102007045113 A1, U.S. Pat. No. 4,216,185 A, DE 19520916 A1, DE 10262036 A1 and FR 2704150 A1. None of the documents mentioned provides a coupling and switching unit that can be connected to all conventional water-carrying unstable or thermally stable line systems.

### SUMMARY

An aspect of the present invention is to provide a coupling and switching unit that can be coupled to conventional water-carrying ring line systems for extremely pure water or water of other qualities, so as to also allow the modern methods of gas introduction, for example, disinfection and sanitization by means of ozone and other oxidizing agents of branch lines, even without active end consumers or end units (for example, hemodialysis units, laboratory and medical equipment, filling installations for liquids).

In an embodiment, the present invention provides for a coupling and switching unit for transporting a gas-containing fluid which includes at least one line having at least one coupling device. The at least one line is configured as a feed line for a gas/liquid mixture. A branched-off line is arranged at the end of the at least one line. The branched-off line is configured to direct the liquid/gas mixture towards an outflow. A throttle valve is arranged in the branched-off line. A valve is configured to control a discharge of a main flow of the gas/liquid mixture.

### BRIEF DESCRIPTION OF THE DRAWINGS

The present invention is described in greater detail below on the basis of embodiments and of the drawings in which:

FIG. 1 shows an embodiment of a coupling and switching unit;

FIG. 2 shows an embodiment of a disinfection of the ring line and of branch lines of a dialysis device; and

FIG. 3 shows an embodiment of a parallel arrangement in which a number of branch lines to end consumers can be specifically perfused and disinfected by means of a switching unit.

### DETAILED DESCRIPTION

In the case of use for ozonization, in the ozonizing phase, for example, the coupling and switching unit may be switched on centrally or decentrally, automatically or manually. After the switching-on command, the solenoid valve is activated and makes a certain flow amount of gas-containing, for example, ozone-containing, water enter the outflow. As a result, the feed-line tube of the dialysis machine is disinfected. The difference is that even inactive units (end consumers) and their branch line can be disinfected. The timing control of the branch line systems takes place in coordination with the exposure, for example, ozonization, of the ring line system (outer disinfection). This unit can consequently be integrated in any existing installation without the latter having to be disassembled or modified. It is consequently suitable not only for the present apparatus, but also for installations elsewhere. The installation can, for example, be designed for pressures of 1 to 15 bar, for example, 2 to 10 bar, and, for example, 2 to 6 bar.

The unit according to the present invention can, for example, be suitable for systems that operate at high pressures. For instance, the feed line can, for example, be designed for pressures of 2 to 6 bar. Higher pressures are, however, also possible. Similarly, the unit according to the present invention is suitable for pressureless states (atmospheric pressure).

For measuring and regulating the throughflow, flow meters can, for example, be arranged in the system. These may concern any of the usual systems that are known to a person skilled in the art. Examples include turbine meters or calorimetric meters.

Venturi nozzles may be used in the feed and removal lines. This is advantageous if liquids or gases or other chemicals are to be introduced. The fitting of the Venturi nozzles offers the advantage that re-contamination of the connections during normal operation of the end unit, for example, during hemodialysis, is avoided. However, this is not absolutely necessary for the apparatus according to the present invention, i.e., the system may operate with high flow rates or with low flow rates.

In an embodiment of the present invention, it can, for example, be a compact, potentially mobile and variable transportable coupling and switching unit. This serves for the connecting of a line, for example, a dialysis ring line, to an end consumer, for example, a dialysis unit. The coupling and switching unit has a line which can be coupled to a liquid line, for example, a dialysis ring line. A flow tube can, for example, be integrated in this attachable line of the apparatus according to the present invention. In an embodiment, an introducing unit for the supply of oxidizing agents or disinfectants, which are, for example, gaseous, can be connected. It may, for example, be an ozone generating unit, which in one variant of the present invention can be generated in a special installation.

Arranged downstream of the introducing unit for the oxidizing agent or disinfectant is a line by means of which the connection to the end consumer unit can take place. Arranged in the region of the connecting point for the end consumer is a throttle valve, by means of which the outflow of the liquid volume can be controlled. The valve can, for example, be arranged at the beginning of a branched-off line, which leads to an outflow via which the liquid can flow out of the unit according to the present invention.

The coupling and switching unit according to the present invention also includes a connecting line between the end consumer unit and the outflow. Accordingly, the liquid outflow from the end consumer units can also take place via this line.

The installation according to the present invention has an advantage that, even in the case of an inactive end consumer unit, for example, a hemodialysis unit, a treatment can take place up to the connector to the end consumer. On the other hand, in addition to the throttle valve, which can, for example, be arranged at the beginning of the branched-off line, a second valve, which can be blocked completely, is provided in the branched-off line to the outflow from the active end consumer. The end consumer can operate during the blocking, for example, a hemodialysis can be carried out with the end consumer.

In the apparatus according to the present invention, it can accordingly be possible to carry a liquid flow from a line, such as a dialysis ring line in the case of carrying out dialyses, to a connection of an end consumer, a hemodialysis unit in the case of carrying out a dialysis. Via a valve, a possibly throttled liquid flow can be carried via a branched-off line to an outflow. The branched-off line may, however, also be blocked by means of a further valve. Furthermore, the unit according to the present invention also allows an outflow of the liquid from the end consumer to take place through a further connecting line by means of the coupling and switching unit according to the present invention.

The unit according to the present invention can, for example, be used wherever gas/liquid systems, such as gas-water systems, are intended to be used, for example, when lengthy standstill times of the liquid flows are to be avoided. This involves systems that use oxidizing agents, for example, gaseous oxidizing agents (for example, ozone). However, other oxidizing disinfectants also come into consideration, such as, for example, sodium hypochlorite, calcium hypochlorite, chlorine, electrolytically prepared chlorine compounds, chlorodioxide solutions, hydrogen peroxide and solutions based on peracetic acid.

The unit according to the present invention can, for example, be suitable for the use of installations in which disinfections and sanitizations are intended to be carried out. Consequently, the unit according to the present invention can be used for the disinfection of dialysis systems. In addition, it can also be used in other areas of medical and laboratory technology and drinking water preparation as well as the conservation of liquids. Use in beverage and beverage vending machines as well as fish and livestock husbandry is likewise conceivable. Further application areas are, for example, hot water, heating and air conditioning technology as well as process and waste-water treatment. The unit according to the present invention offers the advantage here that it can be connected to conventional systems and it is not necessary to invest in a new installation.

An installation that can be used has an inner fluid circulation (inner disinfection) with a device for supplying oxidizing agents and an outer fluid circulation (outer disinfection), which is designed in such a way that it can be operated either separately from the inner circulation or connected to it. The introduction of the oxidizing agent can be achieved with the apparatus according to the present invention. The arrangement of the throttle valve with the branching-off line for the gas/liquid mixture provides the effect that the disinfection and sanitization of the branch line can be carried out even in the case of an inactive end consumer, for example, a hemodialysis unit.

In an embodiment of the present invention, a connection can, for example, be established between the ring line systems of the extremely pure water and the dialysis units. This allows conventional and existing ring and branch line systems also to be provided with ozone technology in the sense of cold disinfection.

However, use in combination with an oxidizing-agent generating installation, such as an installation for generating ozone, can occur according to the present invention. Such an installation can be used in dialysis devices.

However, the coupling and switching unit according to the present invention can also be designed such that it includes a connecting device for the disinfection of suitable containers, various water-related components (for example filters) and end consumers, for example, by means of gaseous oxidizing agents (for example ozone).

In principle, the ozone may be produced from oxygen with the addition of energy by means of so-called silent electrical discharges. The ozone formation takes place here by recombination of an oxygen molecule with an oxygen atom. A splitting of an oxygen molecule by electrical energy must therefore take place. This is achieved in a gas space between two electrodes that are separated by a dielectric. Alternating current and a high-voltage field are applied to the electrodes. The ozone generating units in the form of glass or ceramic tubes are usually positioned in high-grade steel tubes, so that an annular discharge gap that is as narrow as possible is produced. A corresponding number of these ozone generating modules may then be used for the production of amounts of ozone of a few grams/hour up to many kilograms/hour. Either oxygen or air is used as the operating gas.

It is similarly also possible, by using UV light, to generate ozone from the operating gas (oxygen or air), i.e., the electrical splitting of oxygen may also be performed by radiant energy. UV lamps with radiation wavelengths of approximately 185 nm can, for example, be used therefor. At this wavelength, molecular oxygen absorbs energy and is split into atoms. The recombination of the atoms then leads to the ozone molecule. The UV-ozone generators usually consist of an irradiating reactor with a built-in lamp, past which the oxygen-containing operating gas flows and is converted into ozone. These units can, for example, be used for small amounts of ozone of a few grams/hour.

An alternative is production from liquid that contains oxygen, for example, from water. The ozone is here produced by using energy, for example, electrical energy. This involves generating ozone from the oxygen of the water molecule by means of electrolytic water splitting. In a flow cell there are special electrodes (for example, an anode with a solid electrolyte and a cathode), which are flowed around by the water. A DC voltage source generates the required electrolysis current, which leads to the ozone gas generation at the anode. The process concerned can be used primarily for small amounts of ozone of a few grams/hour.

For disinfection, the generated or added oxidizing agent is introduced, for example, in gaseous form, into a fluid circulation, for example, by means of a (Venturi) injector. For example, in the form of a liquid/gas mixture, the oxidizing agent is kept in circulation by means of a circulating pump until a predetermined concentration is kept constant over an adjustable time. The ozone/water mixture can, for example, be passed over a static mixer.

Amperometric sensors can, for example, be used as a standard method for measuring the ozone dissolved in the water. These units have a measuring head with a corresponding electrode/electrolyte system which is either open or covered by a membrane. The measuring system is brought into contact with the water to be measured by a flow cell. Ozone reacts on the working electrode (cathode) and generates a current proportional to the concentration. The current signal is converted by means of a measuring transducer into a unit of concentration (for example milligrams/liters). Regular calibration is of advantage as compared with photometric measuring methods (for example indigo trisulfonate).

If required, the destruction of the ozone may be performed, i.e., the exhaust air can be removed, or optionally returned, via an ozone destroyer, for example, a carbon cartridge. The ozone dissolved in the water can be degraded again into oxygen by irradiation with UV light. For this, the water is passed through a UV reactor with a quartz tube and irradiated medium with UV light, for example, of a wavelength of 254 nm. At this wavelength, the ozone molecule has an absorption maximum and decomposes into oxygen.

Alternatively, the ozone can be degraded both in water and in the gas phase by heterogeneous catalysis on active carbon or mixed oxide granules. Both materials are used in cartridges or reactors.

The coupling and switching device described has advantages over the prior art. As a compact central unit, it can be adapted for any installation and can be used for cold disinfection of the extremely pure water system. The coupling and switching device makes it possible for complete disinfection and sanitization of the ring line systems and the branch lines to be performed without any dead space without active end consumers. The disinfection is effective and inexpensive, since no ring line or transfer module conversion is necessary, and there are virtually no, or only low, consequent costs in comparison with hot disinfection. Furthermore, biofilm formation is completely or largely prevented, and no chemical residues remain. The ozone breaks down into non-toxic oxygen. On the other hand, even very small ozone concentrations are microbiologically very effective.

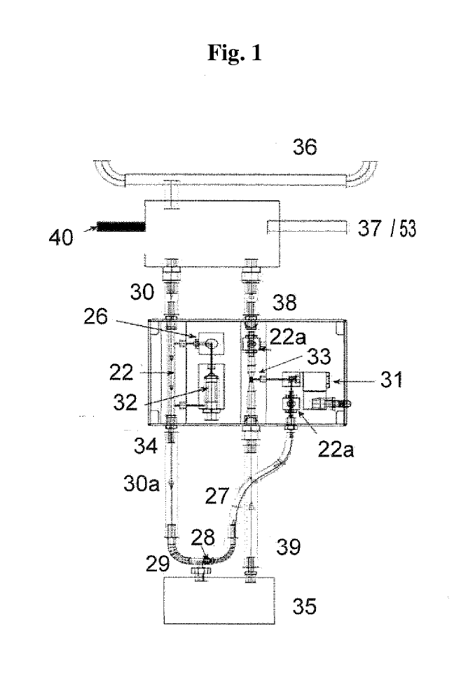

The present invention is explained in more detail below on the basis of FIG. 1-3:

FIG. 1 shows an embodiment of a coupling and switching unit. This connects the dialysis ring line 36 and an end consumer 35, for example a hemodialysis unit. The liquid flow coming from the dialysis ring line 36 is passed via the lines 30 and 30a to the connection 29 just before the end consumer (for example, hemodialysis unit) 35. After being appropriately activated, the solenoid valve 31 allows the outflow of the complete liquid volume from the line 30a, throttled by means of the valve 28, via the branched-off line 27 into the standard outflow 37, which for normal operation of the end consumer (for example, hemodialysis unit) is provided via lines 39 and 38. The disinfection usually takes place by means of gas/liquid perfusion of the branch line to the end consumer 35 (for example, hemodialysis unit) via the lines 30 and 30a up to the connector 29 with an inactive end consumer 35 (for example, hemodialysis unit) outside the treatment times. With normal hemodialysis operation during patient treatment, the liquid flow via the branched-off line 27 is completely blocked by the solenoid valve 31. The liquid outflow from the end consumer (for example, dialysate from a hemodialysis unit) 35 takes place via the lines 39 and 38 to the standard outflow line 37.

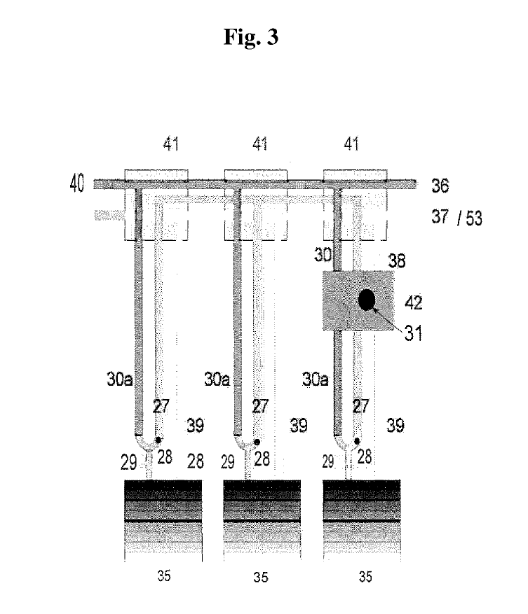

In the apparatus shown, a pressure of 2 to 6 bar prevails in the ring line 36 and at the beginning 30 of the line 30a. The connection 40 can also be used to perform the branch line perfusion of a number of inactive end consumers 35 (for example, hemodialysis units) by means of a coupling and switching unit (cf FIG. 3). The disinfecting gas/liquid mixture (for example, ozone/extremely pure water) may, if need be, be introduced via the ring line 36 into the branch line, fed in via the connection 40 or be introduced locally into an interposed flow tube 22 by means of a gas introducing unit 32 using a pump 26. As an alternative to the standard outflow 37, if need be the liquid flow may also be introduced into a separate collecting container 53.

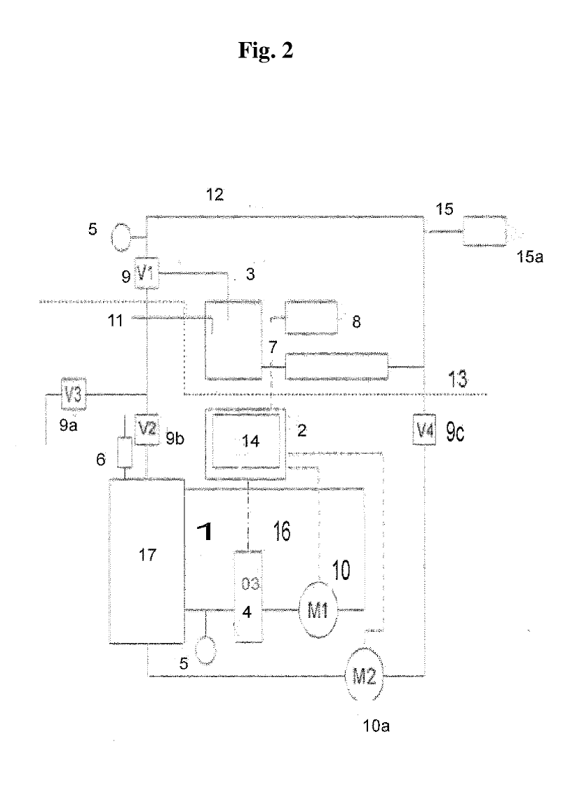

FIG. 2 shows the embodiment of a disinfection of the ring line and of branch lines of a dialysis device: the end consumers 15a of the dialysis device are connected to the ring line (13 flow and 12 return) via the branch line 15. The reverse osmosis control 8 can be switched on or off by means of the start-stop input. The ozone/water mixture coming from the ozone-generating and introducing system 4 is made to enter the working vessel 17. The ozone generator is arranged upstream on the suction side of the circulating pump 10. The control takes place by means of the device 2, which in the embodiment has a touchscreen 14. The ozone concentration can be measured by means of the device 5 in the inner circulation 1 and in the outer circulation 3. By means of the circulating pump 10, the ozone is taken along in the inner circulation and the water is enriched with ozone. As a result, the working vessel 17 undergoes disinfection. The excess ozone can be carried away by means of the degassing device 6.

In the case of the inner disinfection, the ozone concentration of at least 30 ppb in the working vessel 17 is kept constant for about 10 to 15 minutes. Once the disinfection in the inner circulation has been completed, the outer circulation 3 can be attached. This involves the complete dialysis ring lines 13 and 12, and the end consumer(s) 15a attached by means of the branch line(s) 15.

Once a parameterizable ozone concentration has been reached, at least 30 ppb, the adjustable reaction time begins. The ozone concentration in the outer circulation 3 and in the inner circulation 1 is at the same time measured and recorded by means of the ozone measuring device 5.

After completion of the disinfection, the system is flushed out with the permeate of the reverse osmosis via the channel valve V3 (9a). At the same time, the ozone concentration in the return of the ring line 12 is measured. After an adjustable flushing time in which the line is flushed out with a multiple of its content and the ozone concentration in the return 12 of the ring is less than 10 ppb, the flushing is completed and the installation is released again for dialysis.

In the case of an emergency dialysis, the disinfection is interrupted and the installation is flushed as described.

FIG. 3 shows the embodiment of a parallel arrangement in which a number of branch lines (in the shown embodiment 3) to end consumers 35 (for example, hemodialysis units) can be specifically perfused and disinfected by means of a switching unit. This should be understood as a kind of “cluster mode”, in which groups of end consumers can also undergo branch line perfusion by means of a switching unit. The introduction of the disinfecting gas/liquid mixture takes place via the supply 40 and, by means of the switching unit 42 with the valve 31, perfusion of the branch lines (30a, 30) is followed by the discharge of the liquid flow via 38, for example, into the standard outflow 37 of the dialysis device (for example, for dialysate of the hemodialysis units). For this purpose, the branched-off lines 27 are arranged in parallel with the throttle valve 28 and the end consumers are inactive. With normal operation of the end consumers 35, the valve 31 is closed and the waste water flows via the lines 39 in each case into the standard outflow 37. Alternatively, if need be, the discharge of the liquid flow may also be introduced respectively into a separate collecting container 53.

The present invention is not limited to embodiments described herein; reference should be had to the appended claims.

### LIST OF DESIGNATIONS

1 Inner circulation
2 Control device
3 Outer circulation
4 Ozone-generating and introducing device
5 Ozone measuring device
6 Degassing device
7 Connecting line to the reverse osmosis control
8 Reverse osmosis control
9 Dialyzing ring/disinfections switching valve
9a Channel valve
9b Filling valve
10 Circulating pump (inner circulation)
10a Pressure-increasing pump (outer circulation)
11 Soft water replenishment for reverse osmosis
12 Return
13 Flow
14 Touchscreen
15 Branch line(s)
15a End consumer
16 Connection of ozone-generating device 4 to control 2
17 Working vessel
22 Flow tube
22a Flow, temperature, gas-bubble controlling and regulating device
26 Pump
27 Branched-off line
28 Throttle valve
29 Connector to end consumer with internal valve
30 Beginning of line 30a
30a Line to the end consumer
31 Valve
32 Gas introducing agent (Ozone technology)
33 Venturi nozzle
34 Coupling unit to gas introducing agent (ozone technology)
35 End consumer (for example, hemodialysis unit, dialyzer flushing unit, mixing tank for concentrate preparation, sterilizer)
36 Ring line
37 Standard outflow
38 Outflow line
39 Outflow from the hemodialysis unit
40 Connecting line for parallel operation and feeding the disinfectant as a gas/liquid mixture
41 Connecting console for end consumer
42 Coupling and switching unit
52 Feed
53 Collecting container

What is claimed is:

1-12. (canceled)

13. A coupling and switching unit for transporting a gas-containing fluid, the coupling and switching unit comprising:
at least one line having at least one coupling device, the at least one line being configured as a feed line for a gas/liquid mixture;
a branched-off line arranged at the end of the at least one line, the branched-off line being configured to direct the liquid/gas mixture towards an outflow;
a throttle valve arranged in the branched-off line; and
a valve configured to control a discharge of a main flow of the gas/liquid mixture.

14. The coupling and switching unit as recited in claim 13, wherein the coupling and switching unit has an initial pressure of from 1 to 15 bar.

15. The coupling and switching unit as recited in claim 14, wherein the initial pressure is from 2 to 15 bar.

16. The coupling and switching unit as recited in claim 13, further comprising a collecting container, a standard outflow, and a Venturi nozzle, wherein the discharge of the main flow is configured to occur via the Venturi nozzle into the standard outflow or into the collecting container.

17. The coupling and switching unit as recited in claim 16, further comprising at least one flow meter arranged in at least one of the at least one line, and in the branching-off line up to at least one of the standard outflow and the collecting container, the at least one flow meter being configured to at least one of measure, control and regulate a process of the coupling and switching unit.

18. The coupling and switching unit as recited in claim 13, wherein the gas/liquid mixture is a gas/water mixture, and wherein the coupling and switching unit is configured for the gas/water mixture.

19. The coupling and switching unit as recited in claim 13, further comprising at least one of a gas-introducing unit and an ozonizing unit, wherein the coupling and switching unit is configured to have the at least one of the gas-introducing unit and the ozonizing unit be connected thereto.

20. The coupling and switching unit as recited in claim 13, further comprising a flow tube arranged in the at least one line, the flow tube being configured to at least one of introduce, mix and concentrate gaseous constituents.

21. The coupling and switching unit as recited in claim 13, further comprising a connecting device, wherein the connecting device is configured to connect the at least one line to least one of a container, a water-related component, a filter, and an end consumer.

22. Use of the coupling and switching unit as recited in claim 21 to disinfect at least one of the container, the water-related component, the filter, and the end consumer, the use comprising:
providing the coupling and switching unit;
providing the at least one of the container, the water-related component, the filter, and the end consumer; and
disinfecting the at least one of the container, the water-related component, the filter, and the end consumer with the coupling and switching device.

23. The use as recited in claim 22, further comprising introducing a gaseous oxidizing agent, wherein the disinfecting is performed with the gaseous oxidizing agent.

24. The use as recited in claim 23, wherein the gaseous oxidizing agent is ozone.

25. Use of the coupling and switching unit as recited in claim 13 for at least one of disinfecting and sanitizing with an oxidizing agent, the use comprising:
providing the coupling and switching unit;
providing the oxidizing agent;
introducing the oxidizing agent into the coupling and switching unit; and
using the oxidizing agent to at least one of disinfect and sanitize.

26. The use of the coupling and switching unit as recited in claim 25, wherein the oxidizing agent is a gaseous oxidizing agent.

27. The coupling and switching unit as recited in claim 26, wherein the gaseous oxidizing agent is ozone.
